(19) United States
(12) Patent Application Publication
(10) Pub. No.: US 2009/0144811 A1
(43) Pub. Date: Jun. 4, 2009

(54) CONTENT DELIVERY SYSTEM

(75) Inventors: Daisuke MATSUBARA, Tachikawa (JP); Yukiko TAKEDA, Tokorozawa (JP); Kazuho MIKI, Musashino (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(73) Assignee: Hitachi, Ltd.

(21) Appl. No.: 12/240,124

(22) Filed: Sep. 29, 2008

(30) Foreign Application Priority Data
Nov. 30, 2007 (JP) 2007-310665

(51) Int. Cl. H04L 9/32; G06F 15/16

(52) U.S. Cl. 726/5; 709/200

(57) ABSTRACT

The selection of video content to be delivered to a video reproducing terminal is enabled from a communication terminal with WEB function without exposing a user ID. When a terminal makes a transfer request of content data, a web server requests a delivery management server for a transfer ID. The delivery management server issues the transfer ID each time the request is made and transmits it to the web server. The web server transmits the content data to a delivery server. The delivery server stores the content data from the web server correspondingly to the transfer ID. When receiving a delivery request including a transfer ID inputted to a video reproducing terminal from the video reproducing terminal, the delivery server reads the content data corresponding to the received transfer ID, and transmits it to the video reproducing terminal.

### CLAIM OF PRIORITY

The present application claims priority from Japanese patent application JP 2007-310665 filed on Nov. 30, 2007, the content of which is hereby incorporated by reference into this application.

### BACKGROUND OF THE INVENTION

1. Field of the Invention

The present invention relates to a content delivery system, and particularly to a content delivery system in which content data, such as a video, selected by a user using a terminal with WEB function is delivered to another terminal owned by the user and having a video reproduction function.

2. Description of the Related Art

In a video delivery system of the related art, there is a case where in order to view a video, the user uses a terminal suitable for video reproduction, such as a television with network function. In this case, the user browses pages in WEB format displayed on the display of the terminal by using a controller (for example, a remote control of the television) of the terminal, and when finding video content desired to be viewed in the displayed page, the user selects the video content by using the controller and views the video.

Besides, as a system in which a WEB server receives operation contents operated by a communication terminal with WEB function such as a cellular phone, and the operation contents are used for the operation of a video delivery system for a television with network function, a system is disclosed in which user IDs are associated with each other between servers (see, for example, non-patent document 1).

[Non-patent document 1] ID Cooperation Scheme Guideline (ver. 1.0), Mobile IT forum, URL:http://www.mitf.org/public_j/archives/index.html

### SUMMARY OF THE INVENTION

In a terminal, such as a television with network function, for viewing a video in a living room or the like, the operationality of WEB page browsing is generally low. Thus, it is not easy for the user to find desired video content by performing an operation, such as clicking of a link on a WEB page or inputting of a keyword for retrieval, and to request the delivery of the video content. Especially, there are problems that the display is apart from the user by several meters and minute information of the WEB page is hard to see, the arrangement of keys of the remote control and the operation feeling thereof are not suitable for the operation of the WEB page, and the like.

Besides, for example, as in the technique disclosed in non-patent document 1, in the case of the system in which the user IDs are associated with each other between the servers, since it is necessary to share the user ID used in the video delivery system with the WEB server, although there is no problem in the case of cooperation with a reliable WEB server, when cooperation with many and unspecified WEB servers is performed, since the user ID is widely exposed, there is a problem in security.

For example, when there are a first user ID managed by a web server and a second user ID managed by a delivery server, when the user IDs are associated with each other, the delivery server knows the first user ID, and the web server knows the second user ID. When the number of web servers having video content are plural, there is a problem that the respective web servers know the second user ID. In order to prevent the user ID from being exposed to a malicious web server, it is conceivable that the user ID is exposed only to specific web servers. However, only specific video content can be delivered, and this is inconvenient.

In view of the above, it is an object of the invention to provide a video delivery system in which selection of video content to be delivered to a video reproducing terminal, such as a television with network function, can be performed by a communication terminal with WEB function, such as a cellular phone or a PC, without exposing a user ID. Besides, it is another object of the invention to raise security by causing an ID to be shared by a delivery server and a WEB server and by not using an ID by which the user can be identified but using a transfer ID by which the user can not be identified. It is still another object of the invention to deliver video content without exposing a second user ID between a user and a delivery server to a web server and without exposing a first user ID between the user and the web server to the delivery server. Further, it is still another object of the invention to manage which content is delivered to each user.

In a network system in which data of a first server reserved by a first user terminal is received by a second user terminal from a second server, when the data is reserved by the first terminal, the first server makes the data to correspond to a reservation ID (or a transfer ID) and transfers it to the second server, and the second user terminal inputs the transfer ID and transmits it to the second server, and receives the data from the second server.

According to the solving means of this invention, there is provided a content delivery system comprising:

a first server including content data; and

a second server to deliver the content data of the first server, for which a first terminal makes a request to the first server, to a second terminal,

wherein

when the first terminal makes a transfer request of content data, the first server transmits the content data to the second server;

the second server stores the content data from the first server correspondingly to a transfer identifier issued at each time the transfer request is made, and

the second server receives a delivery request including a transfer identifier inputted at the second terminal from the second terminal, reads the content data corresponding to the received transfer identifier and transmits it to the second terminal.

According to the content deliver system described above, selection of video content to be delivered to a video reproducing terminal, such as a television with network function, can be performed by a communication terminal with WEB function, such as a cellular phone or a PC.

Besides, the content deliver system described above, wherein

the first server authenticates the first terminal by using a first user identifier previously determined between the first server and the first terminal,

the second server authenticates the second terminal by using a second user identifier previously determined between the second server and the second terminal, and

the transfer identifier is different from the first user identifier and the second user identifier.

According to the content deliver system described above, it is possible to raise security by causing an ID to be shared by a delivery server and a WEB server and by not using an ID by which the user can be identified but using a transfer ID by which the user can not be identified. For example, it is possible to deliver video content without exposing a second user ID between a user and a delivery server to a web server and without exposing a first user ID between the user and the web server to the delivery server.

Further, the content deliver system described above, wherein

when the second server transmits the content data, identification information of the content data is registered in an account of a user.

According to the content deliver system described above, it is possible to manage which content is delivered to each user.

According to the invention, it is possible to provide a video delivery system in which selection of video content to be delivered to a video reproducing terminal, such as a television with network function, can be performed by a communication terminal with WEB function, such as a cellular phone or a PC. Besides, according to the invention, it is possible to raise security by causing an ID to be shared by a delivery server and a WEB server and by not using an ID by which the user can be identified but using a transfer ID by which the user can not be identified. According to the invention, it is possible to deliver video content without exposing a second user ID between a user and a delivery server to a web server and without exposing a first user ID between the user and the web server to the delivery server. Further, according to the invention, it is possible to manage which content is delivered to each user.

### BRIEF DESCRIPTION OF THE DRAWINGS

FIG. 1 is a view showing a whole structure of a system of an embodiment.

FIG. 2 is a sequence view showing a procedure of transfer ID acquisition in this system.

FIG. 3 is a sequence view showing a procedure of content transfer in this system.

FIG. 4 is a sequence view showing a procedure of video delivery in this system.

FIG. 5 is a view showing a structure of a delivery management server in this system.

FIG. 6 is a view showing a structure of a delivery server in this system.

FIG. 7 is a view showing a transfer ID management table.

FIG. 8 is a view showing a structure of an account management table.

### DETAILED DESCRIPTION OF THE INVENTION

Hereinafter, a video delivery system (content delivery system) of an embodiment will be described in detail with reference to the drawings. Incidentally, in the following, the same reference numeral denotes the same or similar parts.

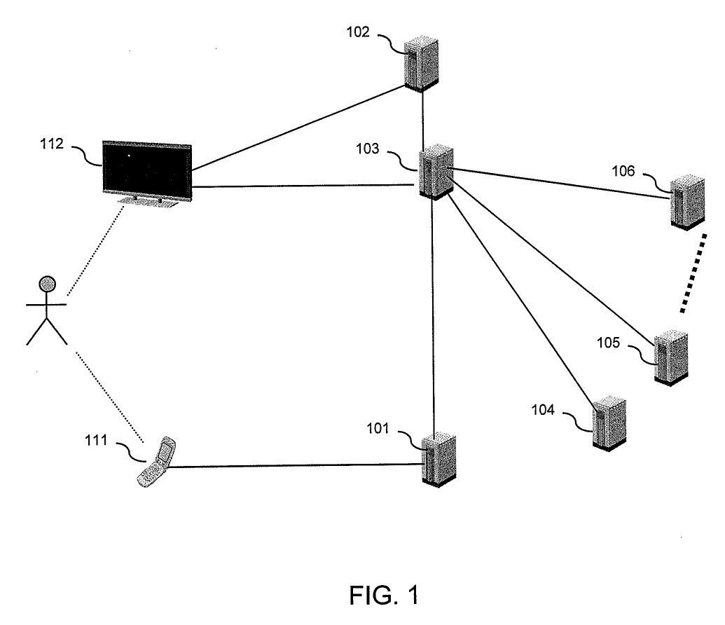

FIG. 1 is a structural view of the video delivery system of the embodiment.

The video delivery system includes, for example, a video reproducing terminal (second terminal) 112, such as a television with network function, used by a user, a communication terminal (first terminal) 111 with WEB function, such as a cellular phone used by the same user, WEB servers (first servers) 101, 104, 105 and 106, a delivery server 103 and a delivery management server 102. These terminals and servers are connected with one another through a network, and messages and data are exchanged through the network. Incidentally, the delivery server 103 and the delivery management server 102 may be constructed by one server or may have separate structures.

The video reproducing terminal 112 is a terminal to reproduce, for example, video content with high image quality and high sound quality, and differently from a PC or the like, the reproduction is performed by a large screen display and a high sound quality speaker. Similarly to a conventional television, the user can view the video for a specific time (for example, several minutes to several hours) from a place apart therefrom by several meters. Although the video reproducing terminal 112 is suitable for video content reproduction, there is a case where it is not suitable for operations of WEB page browsing, such as reading of small characters, selecting of URL links, and inputting of characters.

When the video reproducing terminal 112 is connected to the network, the delivery management server 102 performs equipment authentication of the video reproducing terminal 112 and user authentication. The equipment authentication and the user authentication are performed using a login ID (ID for television, second user ID) and a password which are determined between the video reproducing terminal 112 and the delivery management server 102. The delivery server 103 delivers video content to the video reproducing terminal 112 based on the authentication result transmitted from the delivery management server 102 and a delivery request.

On the other hand, the communication terminal 111 with WEB function is a terminal suitable for WEB page browsing, such as, for example, a cellular phone with WEB function or a PC. The WEB servers 101, 104, 105 and 106 are servers operated by different service providers, and provide WEB pages which can be referred to by the cellular phone or the PC. The service provides use these WEB servers, and provide, for example, e-commerce services, and community services such as Blog and SNS. A certain service provider uses, for example, the WEB server 101 and provides these services, and provides video content for explaining goods, service contents, and the like. The video content includes content which can be reproduced by the communication terminal 111 with WEB function, and content which can be reproduced by the video reproducing terminal 112. The WEB server 101 does not have a function (or authority) to directly deliver the video content to the video reproducing terminal 112. The WEB server delivers the video content to the delivery server 103, and requests the delivery server 103 to deliver the video content, so that the delivery to the video reproducing terminal 112 is performed. The communication terminal 111 with WEB function and the respective WEB servers perform user authentication by using a previously determined login ID (ID for WEB, first user ID) and a password.

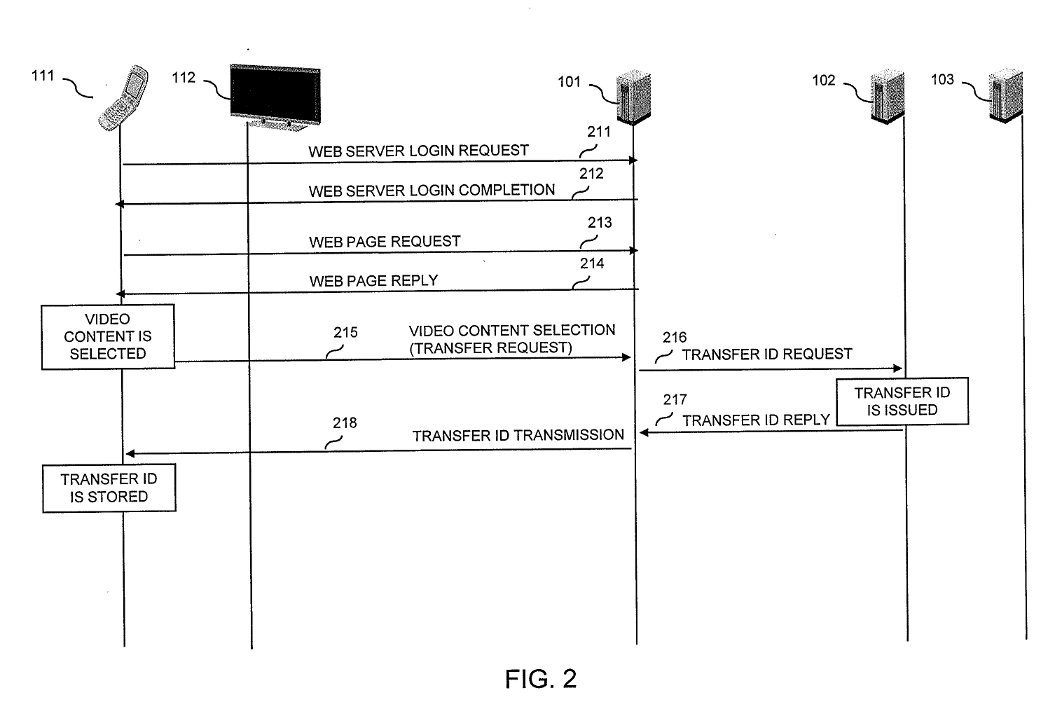

FIG. 2 is a sequence view showing a procedure in which a user uses the communication terminal 111 with WEB function and selects video content in the WEB server 101.

At step 211, the communication terminal 111 with WEB function makes a login request to the WEB server 101. At this time, the communication terminal 111 with WEB function inputs an ID for WEB and a password by user's operation. At step 212, the communication terminal 111 with WEB function receives login completion, and then, at step 213, the communication terminal 111 with WEB function makes a WEB page request in response to the user's operation. At step 214, the WEB server 101 sends a reply of a WEB page for content selection to the communication terminal 111 with WEB function. The communication terminal 111 with WEB function displays the received WEB page, and when desired content is selected on the communication terminal 111 with WEB function by the user's operation, at step 215, the communication terminal 111 with WEB function transmits identification information (for example, content identifier) of the selected video content to the WEB server 101

After receiving the identification information of the video content, the WEB server 101 requests, at step 216, the delivery management server 102 to issue a transfer ID. The delivery management server 102 issues the transfer ID, and sends a reply of the transfer ID to the WEB server 101 at step 217. Incidentally, step 216 and step 217 will be described later in detail.

Finally, at step 218, the WEB server 101 transmits the transfer ID to the communication terminal 111 with WEB function, and the communication terminal 111 with WEB function displays the transfer ID on the display. As a method in which the WEB server 101 delivers the transfer ID to the communication terminal 111 with WEB function, for example, there is a method of displaying it as a WEB page, or a method of transmitting an electronic mail including the transfer ID to a mail address of the user, which is previously registered in the WEB server 101. The transfer ID includes, for example, a numeral of several digits to several tens digits, or alphanumeric characters, and is displayed on the communication terminal 111 with WEB function. The user makes a note of the transfer ID or stores it in the communication terminal 111 with WEB function.

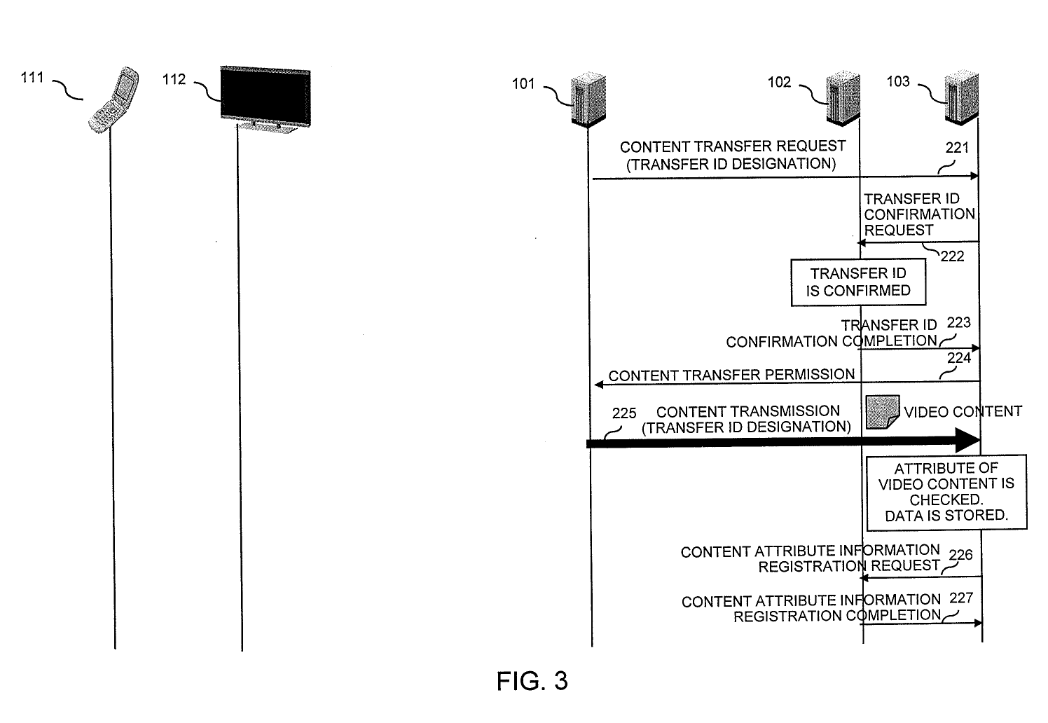

FIG. 3 is a sequence view showing a procedure in which video content is transferred from the WEB server 101 to the delivery server 103. For example, the procedure is executed after the processing of FIG. 2.

At step 221, the WEB server 101 transmits a content transfer request and the transfer ID issued from the delivery management server 102 to the delivery server 103. At step 222, the delivery server 103 transmits a transfer ID confirmation request to the delivery management server 102. The delivery management server 102 confirms the received transfer ID, and when the transfer ID has been issued, at step 223, the delivery management server sends a reply of transfer ID confirmation completion. When the transfer ID has not been issued, a reply that the transfer ID is unusable is sent, and the delivery server 103 rejects the transfer of the content from the WEB server 101. The delivery server 103 having received the transfer ID confirmation completion transmits content transfer permission to the WEB server 101 at step 224.

At step 225, the WEB server 101 transfers the content to the delivery server 103. The delivery server 103 confirms attributes (content name, content provider ID, file capacity, reproduction time, rating, encoding, etc.) of the received content. Besides, the delivery server 103 stores the received content. At step 226, the delivery server 103 transmits a content attribute information registration request to the delivery management server 102. The delivery management server 102 stores the attribute information correspondingly to the transfer ID, and sends a reply of content attribute information registration completion at step 227.

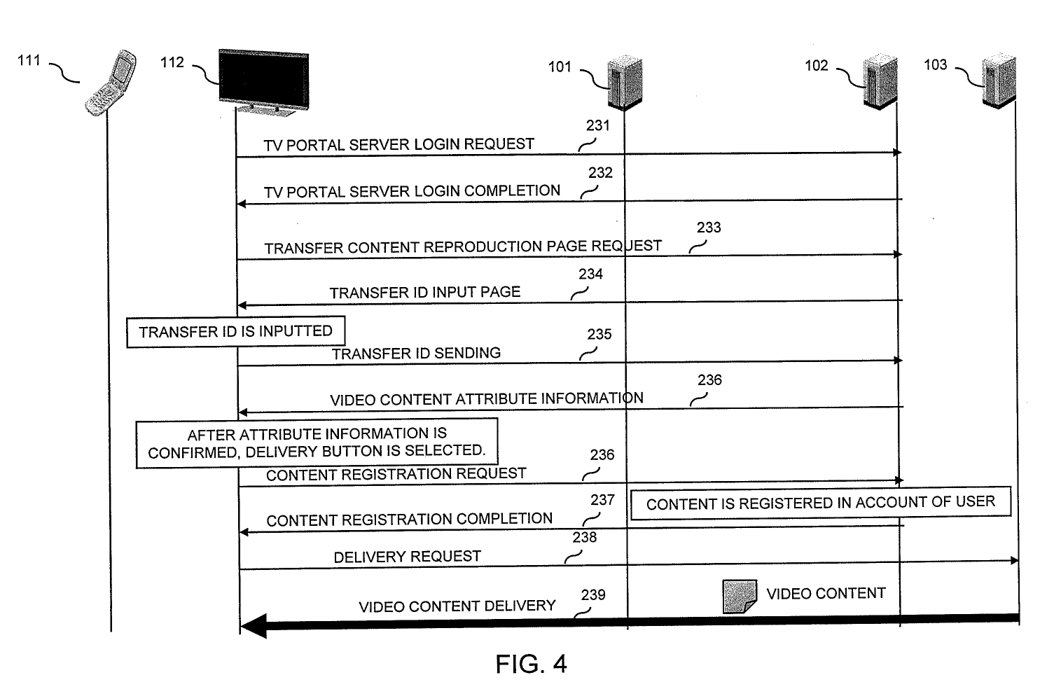

FIG. 4 is a sequence view showing a procedure in which video content is delivery from the delivery server 103 to the video reproducing terminal 112.

At step 231, the video reproducing terminal 112 transmits a TV portal server login request to the delivery management server 102, and at step 232, the delivery management server 102 sends a reply of TV portal server login completion. At this time, in order to perform authentication, the video reproducing terminal 112 transmits a user ID (ID for television) for logging in a TV portal and a password to the delivery management server 102. The user ID and the password are inputted by the user himself/herself using the remote control of the video reproducing terminal 112, or for simplification of the operation, the user ID and the password previously recorded in the video reproducing terminal 112 are used.

At step 233, the video reproducing terminal 112 transmits a transfer content reproduction page request to the delivery management server 102, and at step 234, the delivery management server 102 sends a reply of a transfer ID input page. The video reproducing terminal 112 displays the transfer ID input page on the display, and the user uses the remote control (input device) to input the transfer ID acquired at step 218. For example, in accordance with the transfer ID transmitted from the WEB server 101 to the communication terminal 111 with WEB function and displayed and stored, the transfer ID is inputted into the video reproducing terminal 112 by the user's operation. Incidentally, the input device may be an input device of the main body in addition to the remote control. Besides, the communication terminal 11 with WEB function may be used as the remote control.

At step 235, the video reproducing terminal 112 sends the transfer ID inputted by the user. The delivery management server 102 retrieves the attribute information of the video content made to correspond to the received transfer ID, and sends a reply of the attribute information to the video reproducing terminal 112 at step 236. The video reproducing terminal 112 displays the attribute information of the video content on the display. The user confirms the attribute information, and when there is no problem (when it is certainly what is requested), the user uses the remote control to select a delivery button. At step 236, the video reproducing terminal 112 transmits a content registration request to the delivery management server 102. After registering the video content in the account of the user, the delivery management server 102 sends a reply of content registration completion at step 237. At step 238, the video reproducing terminal 112 having received the content registration completion requests the delivery server 103 to deliver the video content, and at step 239, the delivery server 103 delivers the video content to the video reproducing terminal 112. Incidentally, the video reproducing terminal 112 may be permitted to transmit the delivery request when the content registration completion is received.

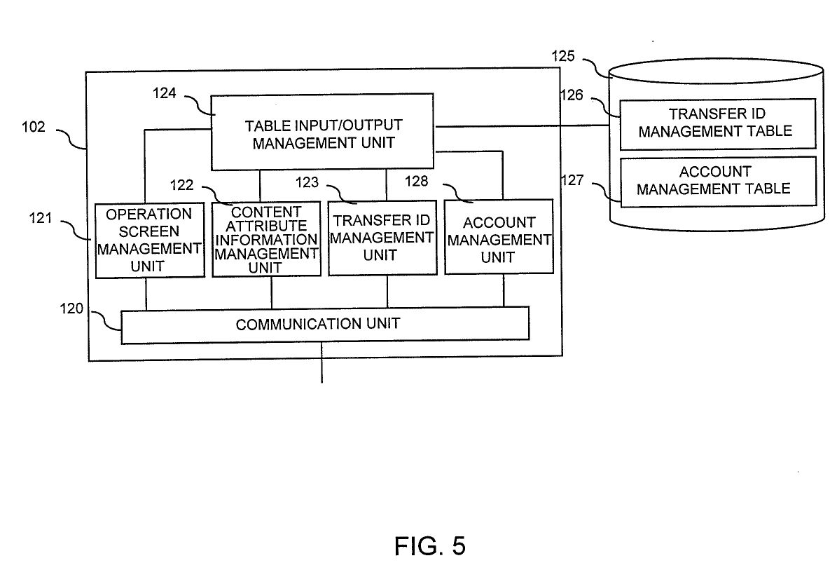

FIG. 5 is a structural view of the delivery management server 102.

The delivery management server 102 includes, for example, a communication unit 102 to communicate with the video reproducing terminal 112 and the WEB server 101, an operation screen management unit 121 to create the transfer ID input page to be transmitted to the video reproducing terminal 112 and to manage the user input information, a content attribute information management unit 122 to manage the attribute information of the video content received from the delivery server 103 and to create a video content attribute confirmation page, a transfer ID management unit 123 to issue the transfer ID and to confirm, a table input/output management unit 124 to manage input/output of various tables, and an account management unit 128 to store the identification information of content data, attribute information, identification information of the user and the like in the account. Besides, a recording device 125 is provided in the inside or outside thereof. The recording device 125 includes a transfer ID management table (transfer identifier storage area) 126 to manage the transfer ID and the attributes of the video content, and an account management table (account storage area) 127.

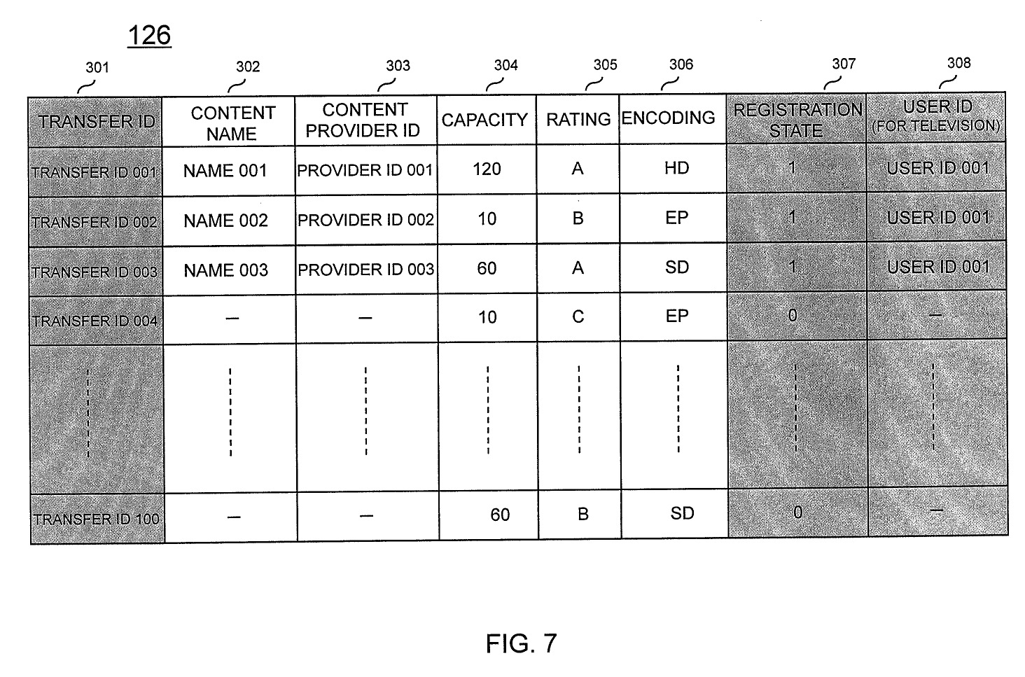

FIG. 7 is a detailed structural view of the transfer ID management table 126.

The transfer ID management table 126 includes, for example, a transfer ID 301, content attribute information, a registration state information 307, and a user ID 308 of the user in whose account the video content is registered.

The content attribute information includes, for example, a content name (or content identification information) 302, a content provider ID 303, a content capacity 304, a rating information 305, and an encoding information 306. The rating information 305 represents the evaluation of contents such as, for example, adult designation or R designation. The encoding information 306 includes, for example, high definition (HD), extended playing (EP), standard definition (SD) and the like. The registration state information 307 indicates whether the transfer ID has been registered in the user account or not. In this example, 0 denotes that the transfer ID has not been registered in the user account, and 1 denotes that it has been registered in the user account.

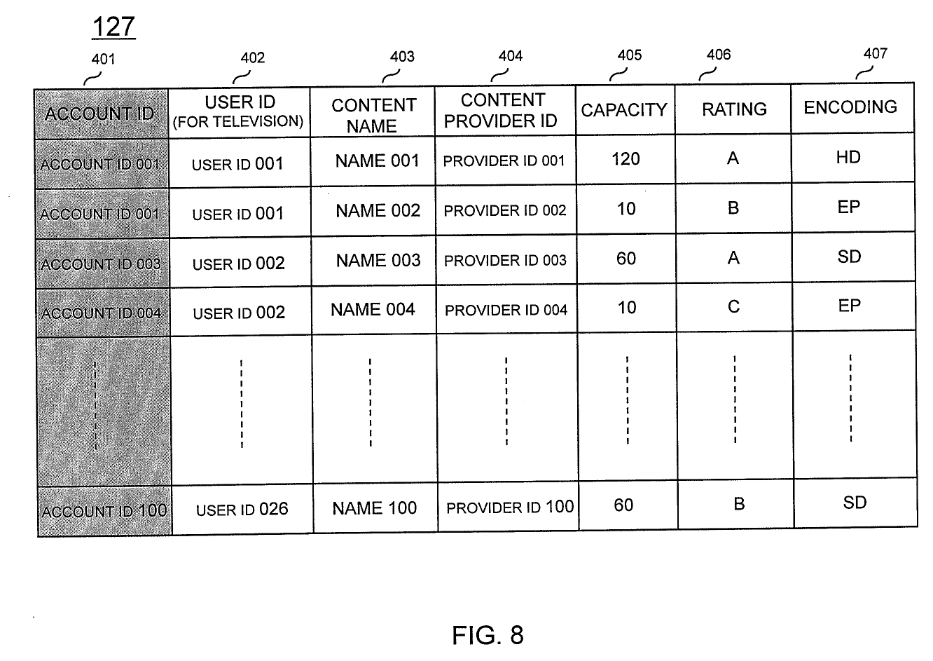

FIG. 8 is a structural view of the account management table.

The account management table 127 stores, for example, a user ID 402, a content name 403, a content provider ID 404, a capacity 405, a rating information 406, and an encoding information 407 with respect to an account ID 401. Incidentally, in the initial state (when content is not registered to any account), nothing is stored.

The account ID is an ID for managing the contract account of the user. The account ID and the user ID are in one-to-one correspondence with each other. The number of contents capable of being registered and the total capacity are determined in advance for the contract account. Besides, charging for content is performed for the account. The user can view the content registered in his/her own account. To register in the account means establishing a state in which the user can view. By that, the charging is also performed.

In the account management table 127 of FIG. 8, all contents registered in the accounts are managed. This can include not only the content transferred using the transfer ID of the embodiment is registered but also the content purchased by a normal method is registered.

In the related art system, only the purchased normal content (the content is originally registered in the delivery server) is registered in the account. In this embodiment, the content obtained and registered by the user using the transfer ID is also registered in this account.

When the content from the web server 101 is newly registered in the delivery server 103, the user ID of the user who registers the content, the account ID corresponding thereto, and the content name 403 to the encoding 407 are all stored.

The content is registered in the account management table 127, so that it is possible to manage which content is held (delivered) in which account. Besides, the capacity of the content to be delivered, the total capacity of plural contents and the like can be managed. Besides, the content obtained by using the transfer ID can be viewed by registering it in the account, and charging is additionally performed. The process for managing these can be executed by, for example, the account management unit 128.

In the sequence of FIG. 2, the operation of the delivery management server when the delivery management server 102 issues the transfer ID will be described with reference to FIG. 5.

At step 216, when receiving the transfer ID request from the WEB server 101, the communication unit 120 delivers the request to the transfer ID management unit 123. The transfer ID management unit 123 forms a new transfer ID and delivers it to the table input/output management unit 124. For example, the transfer ID management unit 123 refers to the transfer ID management table 125 through the table input/output management unit 124, and creates a transfer ID (unassigned ID) which is not registered in the table 125. The table input/output management unit 124 records the created transfer ID in the transfer ID management table 126 in the recording device 125. The transfer ID management unit 123 sends a reply of the transfer ID to the WEB server 101 through the communication unit 120 (FIG. 2: step 217).

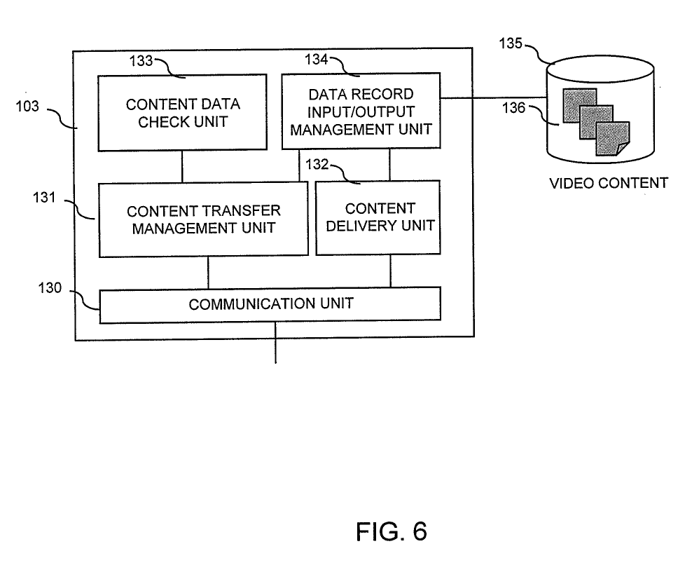

FIG. 6 shows a structure of the delivery server 103.

The delivery server 103 includes, for example, a communication unit 130 to communicate with the delivery management server 102 and the WEB server 101, a content transfer management unit 131 to manage the transfer of video content, a content delivery unit 132 to deliver the video content, a content data check unit 133 to check the data of the video content, and a data record input/output management unit 134 to input/output the data of the video content from/to a recording device 135. The recording device 135 is provided in the inside or the outside. The recording device 135 records video content 136.

In the sequence of FIG. 3, the operation of the delivery management server 102 and the delivery server 103 when video content is transferred from the WEB server 101 to the delivery server 103 will be described with reference to FIG. 5 and FIG. 6.

When receiving the content transfer request and the transfer ID from the WEB server 101 (step 221), the communication unit 130 of the delivery server 103 delivers the transfer ID to the content transfer management unit 131. The content transfer management unit 131 transmits the transfer ID to the delivery management server 102 through the communication unit 120 (step 222).

The communication unit 120 of the delivery management server 102 delivers the received transfer ID to the transfer ID management unit 123. The transfer ID management unit 123 requests the table input/output management unit 124 to search the transfer ID management table 126, and confirms whether the transfer ID is included (the transfer ID is already issued) in the transfer ID management table 126. When the transfer ID is included in the transfer ID management table 126, transfer ID confirmation completion is sent to the delivery server 103 through the communication unit 120 (step 223).

When the communication unit 130 of the delivery server 103 receives the transfer ID confirmation completion, the content transfer management unit 131 transmits content transfer permission to the WEB server 101 through the communication unit 130 (step 224). When the communication unit 130 of the delivery server 103 receives the data of the video content and the transfer ID from the WEB server 101 (step 225), the content transfer management unit 131 records the video content 136 in the recording device 135 through the data record input/output management unit 134. For example, the transfer ID and the video content are made to correspond to each other and are stored. Incidentally, the delivery server may receive the content name, content provide ID and the like from the web server 101 in addition to the video content.

The content data check unit 133 of the delivery server 103 checks the attribute of the video content. For example, the content data check unit 133 obtains the respective information of capacity, rating, and encoding of the received content. Incidentally, the respective information is obtained by the web server 101 or is previously set, and may be transmitted to the delivery server 103.

The content data check unit 133 transmits a content attribute information registration request including the attribute information, such as content name, content provider ID, content capacity, rating and encoding, and the transfer ID to the delivery management server 102 (step 226). The content attribute information management unit 122 of the delivery management server 102 stores the attribute information in the transfer ID management table 125 in accordance with the content attribute information registration request and correspondingly to the transfer ID. Besides, the content attribute information management unit 122 transmits the content attribute information registration completion to the delivery server 103 (step 227).

In the sequence of FIG. 4, the operation of the delivery management server 102 and the delivery server 103 when video content is delivered will be described with reference to FIG. 5 and FIG. 6.

When receiving a TV portal server login request from the video reproducing terminal 112 (step 231), the delivery management server 102 uses the user ID for television and the password included in the request and performs authentication, and when the authentication is performed, the delivery management server transmits TV portal server login completion to the video reproducing terminal 112 (step 232). Besides, when receiving a transfer content reproduction page request from the video reproducing terminal 112 (step 233), the delivery management server 102 sends a reply of a transfer ID input page (step 234). Incidentally, the respective processings (steps 231 to 234) can be executed by the operation screen management unit 121.

When receiving the transfer ID from the video reproducing terminal 112 (step 235), the content attribute information management unit 122 refers to the transfer ID management table 125, and acquires the attribute information corresponding to the received transfer ID. The content attribute information management unit 122 transmits the acquired attribute information to the video reproducing terminal 112 (step 236). The video reproducing terminal 112 displays the received attribute information. The user confirms that the video content is what is requested, and selects a delivery button to transmit a content registration request.

The account management unit 128 registers the user ID of the video reproducing terminal, from which the content registration request is received, in the user ID corresponding to the transfer ID of the transfer ID management table 126 through the table input/output management unit 124, and sets a registration state to 1. Besides, the account management unit 128 refers to the transfer ID management table 126, acquires the information, such as the content name 302, the content provider ID 303, the capacity 304, the rating 305, and the encoding 306, corresponding to the transfer ID, and registers the respective acquired information in the account management table 127 correspondingly to the account ID and the user ID.

When the communication unit 130 of the delivery server 103 receives the delivery request including the transfer ID from the video reproducing terminal 112 (step 238), the content delivery unit 132 reads the video content corresponding to the received transfer ID through the data record input/output management unit 134, and delivers it to the video reproducing terminal 112 (step 239).

The present invention can be used for, for example, a communication system for delivering content data such as video.

What is claimed is:

1. A content delivery system comprising:
a first server including content data; and
a second server to deliver the content data of the first server, for which a first terminal makes a request to the first server, to a second terminal,
wherein
when the first terminal makes a transfer request of content data, the first server transmits the content data to the second server;
the second server stores the content data from the first server correspondingly to a transfer identifier issued at each time the transfer request is made, and
the second server receives a delivery request including a transfer identifier inputted at the second terminal from the second terminal, reads the content data corresponding to the received transfer identifier and transmits it to the second terminal.

2. The content delivery system according to claim 1, wherein
the first server authenticates the first terminal by using a first user identifier previously determined between the first server and the first terminal,
the second server authenticates the second terminal by using a second user identifier previously determined between the second server and the second terminal, and
the transfer identifier is different from the first user identifier and the second user identifier.

3. The content delivery system according to claim 1, wherein
when the first terminal makes the transfer request of the content data, the first server requests the second server for the transfer identifier, and
the second server issues the transfer identifier and transmits it to the first server.

4. The content delivery system according to claim 3, wherein the second server includes:
a transfer identifier storage area to store the issued transfer identifier; and
a transfer identifier management unit that refers to the transfer identifier storage area, newly issues a transfer identifier other than the already issued transfer identifier, stores the issued transfer identifier in the transfer identifier storage area, and transmits the issued transfer identifier to the first server.

5. The content delivery system according to claim 3, wherein
the first server transmits the transfer identifier received from the second server to the first terminal, and the transfer identifier is displayed on the first terminal.

6. The content delivery system according to claim 1, wherein
when the second server transmits the content data, identification information of the content data is registered in an account of a user.

7. The content delivery system according to claim 6, wherein
the second server includes an account storage area in which the identification information of the content is stored correspondingly to an account identifier of the user, and
when receiving the delivery request from the second terminal, the second server stores the identification information of the content corresponding to the transfer ID included in the delivery request into the account storage area.

8. The content delivery system according to claim 1, wherein
the second server includes a transfer identifier management table in which attribute information including one of or two or more of a content name, a content provider information, a content data capacity, a rating information indicating an evaluation of the content, and an encoding information of the content data are stored correspondingly to the transfer identifier,
the second server obtains attribute information by referring to the received content data or acquires it from the first server,
the second server stores the attribute information in the transfer identifier management table correspondingly to the transfer identifier, and
when receiving the delivery request including the transfer identifier from the second terminal, the second server transmits the attribute information corresponding to the transfer identifier to the second terminal, and causes the second terminal to display the attribute information.

9. The content delivery system according to claim 1, wherein
the second terminal is a terminal that can reproduce video content, logs in the second server by using a second user identifier and a second password previously registered in the second server, and then transmits the delivery request of the content data.

10. The content delivery system according to claim 1, wherein
the first terminal logs in the first server by using a first user identifier and a first password previously registered in the first server, and then transmits the transfer request of the content data.

11. The content delivery system according to claim 3, wherein
the second server includes:
a delivery management server that issues a transfer identifier in response to the request from the first server and transmits it to the first server; and
a delivery server that stores the content data from the first server correspondingly to the transfer identifier, and when receiving the delivery request including the transfer identifier from the second terminal, the delivery server reads the content data corresponding to the received transfer identifier, and transmits it to the second terminal.
